(19) United States
(12) Patent Application Publication
(10) Pub. No.: US 2024/0099323 A1
(43) Pub. Date: Mar. 28, 2024

(54) POURABLE AND SPRAYABLE LIQUID ANIMAL FAT COOKING COMPOSITION

(71) Applicant: South Chicago Packing LLC, Chicago, IL (US)

(72) Inventors: Kiran Jason Kanesvaran, Parrish, FL (US); Duane Fimreite, Chicago, IL (US)

(21) Appl. No.: 18/373,928

(22) Filed: Sep. 27, 2023

Related U.S. Application Data
(60) Provisional application No. 63/410,991, filed on Sep. 28, 2022.

(51) Int. Cl. A23D 9/00; B65D 83/62

(52) U.S. Cl. CPC A23D 9/00; B65D 83/62

(57) ABSTRACT

The present disclosure relates to a cooking composition that is a pourable and sprayable liquid at room temperature (68-74° F.) comprising fractionated animal fat such as Wagyu beef tallow, a cooking spray comprising the composition and a method for flavoring savory foods with the composition.

### CROSS-REFERENCE TO RELATED APPLICATION

This application claims the benefit of and priority to U.S. Provisional Application No. 63/410,991 filed Sep. 28, 2022, the contents of which are incorporated by reference.

### FIELD OF THE DISCLOSURE

The present disclosure relates to a cooking composition that is a pourable and sprayable liquid at room temperature (68-74° F.) comprising fractionated animal fat such as Wagyu beef tallow, a cooking spray comprising the composition and a method for flavoring savory foods with the composition.

### BACKGROUND

Animal fats have been used as an aid for cooking for thousands of years. Animal fats, in particular tallow and lard, are desirable in cooking for their flavor, to give certain foods desirable texture, to aid other ingredients in sticking together, and as a flavor base to enhance other flavors prepared with the cooked food. However, animal fats, such as tallow and lard, are solid at room temperature and must be heated to a temperature sufficient to melt such animal fats into a liquid state before they can be used. The heating process can create an undesirable mess and alter the flavor of such animal fats, making it difficult to use or undesirable in certain cooking situations.

One alternative to animal fat to aid cooking is vegetable-based oils. Many vegetable-based fats are liquid at room temperature. However, tropical vegetable fats, such as coconut oil, palm oil, and palm kernel oil are solid at room temperature. These tropical vegetable-based fats can be fractionated to create liquid vegetable oils of varying viscosities and purities. The process of fractionation separates a compound into its constituent components based on those components' solubility at a given temperature. Vegetable oils, including fractionated coconut, palm, and palm kernel oil, are liquid at room temperature and are relatively easy to cook and prepare food with. However, these vegetable-based fats have a distinct flavor profile, which may not be desirable in certain cooking and food preparation contexts.

Thus, there exists a long-felt, unmet need for animal fat that is pourable and sprayable—i.e. liquid—at room temperature that is easy to cook with in a variety of cooking situations.

### SUMMARY

The present disclosure relates to a cooking composition that is a pourable and sprayable liquid at room temperature comprising fractionated animal fat and that can be applied to a cooking surface or directly onto food from a sprayable container.

In one aspect of the present disclosure, a composition is configured to be applied to food with a pressurized spray canister, such as a “bag on valve” (BOV) canister so that the composition can be sprayed directly on a cooking surface or implement or onto food to enhance the flavor.

In another aspect of the present disclosure, a composition is formed from fractionated Wagyu beef tallow.

The inventors believe that fractionated grass-fed beef tallow, which is more akin to Wagyu beef tallow as compared to grain-fed beef tallow, would produce relatively equivalent results as the composition comprising fractionated Wagyu beef tallow.

It is believed that fractionated swine lard, bacon fat, pork skin fat, and other similar fats can be useful as well, provided that the same characteristics of the composition as described herein are achieved.

It is noted that in this disclosure and particularly in the claims and/or paragraphs, terms such as “comprises,” “comprised,” “comprising” and the like can have the meaning attributed to it in U.S. Patent law; e.g., they can mean “includes,” “included,” “including,” and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by the following Detailed Description.

### DETAILED DESCRIPTION

Most all animal fats are naturally solid at room temperature. This is true for tallow, a rendered form of beef or sheep fat, and lard, a rendered form of swine fat Animal fats are solid at room temperature because they are composed of saturated fatty acids, predominately palmitic acid, stearic acid, and oleic acid. Palmitic acid has a melting point of 62.9° C. (145.2° F.). Stearic acid has a melting point of 69.3° C. (156.7° F.). Oleic acid, however, has a melting point of approximately 13° C. (56° F.). Of these, only oleic acid is a liquid at room temperature, 20-23° C. (68-74° F.).

Fractionated animal fats are used in the present disclosure. Fractionation is the process by which oils or fats are crystallized, which can be accomplished without a solvent (dry fractionation) or in the presence of a solvent, such as acetone or hexane, and then separated with a membrane to isolate the olein fats. Dry fractionated animal fats are preferred here because they avoid the use of additional solvents, such as acetone or hexane. The use of additional solvents is not preferred because solvents can alter the flavor profile of the food. Further, many of the solvents used in fractionation are volatile and therefore ill-suited to use in a food preparation environment. Finally, the use of solvents introduces unneeded chemicals into the production process. Consumers have become more conscious of the ingredients in their food, and are seeking more natural products. Dry fractionated animal fats do not require the use of any added solvents, and therefore are preferred here.

An exemplary embodiment of the present disclosure is directed to a cooking composition that is a pourable and sprayable liquid at room temperature (68-74° F.) comprising fractionated animal fat having a total saturated fat content approximately in the range of 33.9-34.7% including a palmitic acid content in the range of 20.4-20.7% and a stearic acid content in the range of 9.4-10.1%, a total monosaturated fat content approximately in the range of 49.3-52.5% which includes an oleic acid content in the range of 42.5-45.3%, a palmitoleic acid content in the range of 4.3-4.9%, a total polyunsaturated fat content approximately in the range of 2.4-3.0%, a total trans-fat content of 3.7-5.5%, a conjugated linoleic acid content approximately in the range of 0.65-0.68%, a Mettler dropping point approximately in the range of 17-18° C., and iodine value approximately in the range of 56-64 gI/100 g, and a free fatty acid value approximately in the range of 0.4-0.7%.

Another exemplary embodiment of the present disclosure is directed to a canned cooking spray comprising a metal spray can; a compressed inert gas; a spray nozzle; a cooking composition that is a pourable and sprayable liquid at room temperature (68-74° F.) comprising fractionated animal fat having a total saturated fat content approximately in the range of 33.9-34.7% including a palmitic acid content in the range of 20.4-20.7% and a stearic acid content in the range of 9.4-10.1%, a total monosaturated fat content approximately in the range of 49.3-52.5% which includes an oleic acid content in the range of 42.5-45.3% a palmitoleic acid content in the range of 4.3-4.9%, a total polyunsaturated fat content approximately in the range of 2.4-3.0%, a total trans-fat content of 3.7-5.5%, a conjugated linoleic acid content approximately in the range of 0.65-0.68%, a Mettler dropping point approximately in the range of 17-18° C., and iodine value approximately in the range of 56-64 gI/100 g, and a free fatty acid value approximately in the range of 0.4-0.7%, a food grade bag-on-valve (BOV) that houses the composition within the metal spray can and prevents direct contact of the composition with the compressed inert gas and metal spray can.

Another exemplary embodiment of the present disclosure is directed to flavoring savory foods with the composition, whereby the composition that is a pourable and sprayable liquid at room temperature (68-74° F.) comprising fractionated animal fat having a total saturated fat content approximately in the range of 33.9-34.7% including a palmitic acid content in the range of 20.4-20.7% and a stearic acid content in the range of 9.4-10.1%, a total monosaturated fat content approximately in the range of 49.3-52.5% which includes an oleic acid content in the range of 42.5-45.3% a palmitoleic acid content in the range of 4.3-4.9%, a total polyunsaturated fat content approximately in the range of 2.4-3.0%, a total trans-fat content of 3.7-5.5%, a conjugated linoleic acid content approximately in the range of 0.65-0.68%, a Mettler dropping point approximately in the range of 17-18° C., an iodine value approximately in the range of 56-64 gI/100 g, and a free fatty acid value approximately in the range of 0.4-0.7%, is installed in a spray can with a compressed inert gas , the spray can is positioned about 6 inches away from food or implement; and pressing the nozzle of the spray can to release the composition from the spray can onto the food or implement.

The compositions properties are such that it contains a lower percentage of palmitic acid and stearic acid and an increased percentage of unsaturated fat content as compared to solid animal based fats traditionally used in cooking such as solid Wagyu beef tallow, solid beef tallow and solid swine lard. In general, the lower the saturated fat content the more likely a fat will be solid at room temperature.

To measure the quality of the animal fat product samples, the inventors analyzed the specific fat content, including saturated fat, monounsaturated fat, polyunsaturated fat and trans-fat content, conjugated linoleic acid content, free fatty acid content, iodine value and Mettler dropping point values for each sample. The samples in Tables 1 and 3 below were sent to an independent third party laboratory to obtain data as to saturated fat, monounsaturated fat, polyunsaturated fat and trans-fat content, as well conjugated linoleic acid content. The samples in Tables 2 and 3 were tested internally by the inventors to determine the free fatty acid content, iodine value and Mettler dropping point values for each sample.

The following Table 1 includes analytical data from the inventors relating to the present disclosure comprising values for three lots of the composition comprising Wagyu beef tallow and the average of lots 1 though 3 of the composition comprising Wagyu beef tallow.

Wagyu beef tallow is beef tallow rendered strictly from U.S.-grown strains of Wagyu cattle. The American Wagyu Association's Specification for Characteristic's of Cattle Eligible for Approved Programs Claiming Wagyu Influence sets forth the following requirements for live cattle from which carcasses can be derived for certification in approved branded beef programs claiming Wagyu influence: “(2.1) Cattle eligible for Wagyu Fullblood (100% Wagyu) certified beef programs must be registered with the American Wagyu Association and DNA parent verified through the American Wagyu Association to both sire and dam. Both parents will be registered by the American Wagyu Association. (2.2) Cattle eligible for Wagyu Purebred (93.75% Wagyu minimum) certified beef (2.3) programs must be registered with the American Wagyu Association and DNA parent verified through the American Wagyu Association to both sire and dam. Both parents will be registered by the American Wagyu Association; (2.3) Cattle eligible for Wagyu influence certified beef programs must have positive identification (e.g. ear tags, tattoos, brands) and be traceable to provable (e.g. registration papers) Wagyu parentage. Qualifying cattle must be traceable to at least one registered parent (Fullblood or Purebred). The registration categories can be viewed at www.wagyu.org. For an animal to qualify as Wagyu, subsequently allowing the meat from the animal to be eligible to claim Wagyu influence, the animal must be an offspring of: (2.3.1) A registered sire of at least 15/16 or 93.75% Wagyu blood (i.e. Fullblood or Purebred) or; (2.3.2) A registered dam of at least 15/16 or 93.75% Wagyu blood (i.e. Fullblood or Purebred).”

TABLE 1

| | | | | Average of |
|---|---|---|---|---|
| | Lot 1- | Lot 2- | Lot 3- | Lots 1-3 |
| | Composition | Composition | Composition | Composition |
| | comprising | comprising | comprising | comprising |
| | Wagyu Beef | Wagyu Beef | Wagyu Beef | Wagyu Beef |
| | Tallow | Tallow | Tallow | Tallow |
| Total Saturated Fat | 34.66 | 33.99 | 34.61 | 34.42 |
| (%) | | | | |
| Palmitic | 20.696 | 20.427 | 20.421 | 20.514 |
| (16:0) (%) | | | | |
| Stearic Acid | 10.043 | 9.485 | 9.972 | 9.83 |
| (18:0) (%) | | | | |
| Total | 52.41 | 51.50 | 49.32 | 51.07 |
| Monounsaturated Fat | | | | |
| (%) | | | | |
| Oleic | 45.228 | 44.072 | 42.564 | 43.954 |
| (18:1)(%) | | | | |
| Palmitoleic | 4.728 | 4.872 | 4.307 | 4.625 |
| (16:1) (%) | | | | |
| Total Polyunsaturated | 2.95 | 2.43 | 2.52 | 2.63 |
| Fat (%) | | | | |
| Total Trans Fat (%) | 3.78 | 5.10 | 5.43 | 4.77 |
| Conjugated Linoleic | 0.678 | 0.661 | 0.65 | 0.67 |
| Acid (%) | | | | |

The following Table 2, includes additional analytical data such as Mettler dropping point, iodine value, and free fatty acids from the inventors relating to the present disclosure comprising values for three different lots of the composition comprising Wagyu beef tallow and the average of lots 4 though 6 of the composition comprising Wagyu beef tallow.

TABLE 2

| | | | | Average of |
|---|---|---|---|---|
| | Lot 4- | Lot 5- | Lot 6- | Lots 4-6 |
| | Composition | Composition | Composition | Composition |
| | comprising | comprising | comprising | comprising |
| | Wagyu Beef | Wagyu Beef | Wagyu Beef | Wagyu Beef |
| | Tallow | Tallow | Tallow | Tallow |
| Mettler Dropping Point (° C.) | 17.2 | 17.9 | 17.5 | 17.3 |
| Iodine Value (gI/100 g) | 63.39 | 56.33 | 56.50 | 58.74 |
| Free Fatty Acid (%) | 0.67 | 0.50 | 0.45 | 0.54 |

The following Table 3 includes analytical data from the inventors relating to solid raw filtered Wagyu beef tallow, solid raw rendered grass-fed beef tallow, and solid raw rendered grain-fed beef tallow.

TABLE 3

| | Solid Raw | Solid Raw | Solid Raw |
|---|---|---|---|
| | Filtered | Rendered | Rendered |
| | Wagyu | Grass-fed | Grain-fed |
| | Beef Tallow | Beef Tallow | Beef Tallow |
| Total Saturated Fat | 36.73 | 37.26 | 43.66 |
| (%) | | | |
| Palmitic | 21.72 | 22.72 | 22.65 |
| (16:0) (%) | | | |
| Stearic Acid | 10.48 | 9.86 | 15.47 |
| (18:0) (%) | | | |
| Total | 47.23 | 46.62 | 39.63 |
| Monounsaturated Fat | | | |
| (%) | | | |
| Oleic | 40.56 | 38.42 | 35.46 |
| (18:1) (%) | | | |
| Palmitoleic | 4.20 | 5.521 | 2.43 |
| (16:1) (%) | | | |
| Total | 2.68 | 1.80 | 2.74 |
| Polyunsaturated Fat | | | |
| (%) | | | |
| Total Trans Fat (%) | 4.53 | 4.28 | 6.17 |
| Conjugated Linoleic | 0.60 | 1.128 | 0.08 |
| Acid (%) | | | |
| Mettler Dropping | 37.1 | x | 39.60 |
| Point (° C.) | | | |
| Iodine Value | 48.4 | x | 50.49 |
| (gI/100 g) | | | |
| Free Fatty Acid (%) | 0.36 | x | 0.3 |

As can be seen when comparing the properties in Tables 1 and 2 of the composition comprising fractionated Wagyu beef tallow with the properties of raw, filtered, Wagyu beef tallow that is solid at room temperature in Table 3, the properties of the composition, which is liquid, pourable, and sprayable at room temperature, differ from those of the raw filtered Wagyu beef tallow. The raw filtered Wagyu beef tallow in Table 3 had an average total saturated fat content of 36.73%, including a Palmitic acid content of 21.72% and a stearic acid content of 10.48%, a total monosaturated fat content of 47.23%, which includes an oleic acid content of 40.56% and a palmitoleic acid content of 4.20%, a total polyunsaturated fat content of 2.68%, a total trans-fat content of 4.53%, and a conjugated linoleic acid (CLA) content of 0.60%. The raw filtered Wagyu beef tallow had a Mettler dropping point of 37.1° C., an iodine value of 48.4 gI/100 g, and a free fatty acid content of 0.36%.

As shown in Table 1, the average of lots 1 through 3 of the composition comprising Wagyu beef tallow had a total saturated fat content of 34.42%, including a Palmitic acid content of 20.514% and a stearic acid content of 9.83%, a total monosaturated fat content of 51.07%, which includes an oleic acid content of 43.954%, and a palmitoleic acid content of 4.625%, a total polyunsaturated fat content of 2.63%, a total trans-fat content of 4.77%, and a conjugated linoleic acid (CLA) content of 0.67%. As shown in Table 2, the average of lots 4 through 6 of the composition comprising Wagyu beef tallow further had a Mettler dropping point of 17.3° C., an iodine value of 58.74 gI/100 g, and a free fatty acid content of 0.54%.

The inventors anticipate that fractionated grass-fed beef tallow properties would produce a composition that is relatively equivalent to the composition comprising fractionated Wagyu tallow. For example, the solid raw rendered grass-fed beef tallow properties in Table 3 are more similar in value to solid raw filtered Wagyu beef tallow than they are to the solid raw rendered grain-fed beef tallow.

The composition may be stored in a variety of containers, preferably in a “bag-on-valve” (BOV) container. A bag-on-valve container is advantageous over other container options for a number of reasons. Unlike traditional aerosolized canisters, which require antioxidants and often use flammable propellants, such as butane or other hydrocarbon propellants, a bag-on-valve system allows for the composition to be poured into an inert pouch which is fitted into a spray can canister and surrounded by a compressed inert gas such as compressed ambient air. Another option is to use pressurized gas, such as, for example, nitrogen or carbon dioxide in lieu of compressed ambient air. Moreover, unlike other cooking sprays such as PAM®, where the hydrocarbon propellant is dissolved into the substance with 10-18% propane, butane, or another hydrocarbon propellant, the present composition within the bag-on-valve does not come into direct contact with the compressed inert gas of the spray canister. The use of a BOV results in a more pure composition which is protected from the pressurized gas and avoids the use of a hydrocarbon propellant and is therefore safer to use as it contains fewer additives. The use of a BOV also extends the shelf life of the composition. Other containers for the composition are also contemplated as would be obvious to one of ordinary skill in the art.

The uses of the pourable and sprayable liquid composition in the present disclosure, include, without limitation, as a flavor enhancer when applied directly to savory foods, as an aid in cooking for frying, sautéing and searing various foods, as a fat source, as a binder for seasonings in cooking, and as a flavor or sensory additive in sport fishing, where the composition can be used directly on the surface of the water (chumming) or by spraying the composition onto a fishing lure to attract fish, or incorporated with additional dry additives to serve as a binder to form a dry chum or fish meal.

Generally, this disclosure is directed toward pourable and sprayable cooking composition comprising animal fat which is liquid at room temperature.

After crystallization and separation, the isolated composition can be used as a pourable and sprayable liquid cooking fat as other non-animal-based fats, such as olive oil, are used. The composition can be applied to food directly or onto cooking implements with spray canister filled with compressed inert gas, such as compressed ambient air or a pressurized carbon dioxide or nitrogen gas. When applied with a spray canister, the composition is inserted into a bag-on-valve that is placed into a spray can. The spray can is then pressurized, to between 40-60 PSI, with preferably an inert, non-flammable gas, such as compressed air, carbon dioxide or nitrogen gas. The composition is applied to food or cooking implements by depressing a nozzle on the spray can, which causes the compressed gas to force the composition out of the bag-on-valve within the spray can through the spray nozzle and onto food or cooking implements.

Although the present invention and its advantages have been described in detail, it should be understood that various changes, substitutions and alterations can be made herein without departing from the spirit and scope of the invention as defined in the appended claims.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A cooking composition that is a pourable and sprayable liquid at room temperature (68-74° F.) comprising fractionated animal fat having a total saturated fat content approximately in the range of 33.9-34.7% including a palmitic acid content in the range of 20.4-20.7% and a stearic acid content in the range of 9.4-10.1%, a total monosaturated fat content approximately in the range of 49.3-52.5% which includes an oleic acid content in the range of 42.5-45.3% a palmitoleic acid content in the range of 4.3-4.9%, a total polyunsaturated fat content approximately in the range of 2.4-3.0%, a total trans-fat content of 3.7-5.5%, a conjugated linoleic acid content approximately in the range of 0.65-0.68%, a Mettler dropping point approximately in the range of 17-18° C., an iodine value approximately in the range of 56-64 gI/100 g, and a free fatty acid value approximately in the range of 0.4-0.7%.

2. The composition of claim 1 wherein said animal fat is Wagyu beef tallow and has a stearic acid value in the range of 9.4-10.1%.

3. The composition of claim 1 wherein said animal fat is Wagyu beef tallow and has a palmitic acid value in the range of 20.4-20.7%.

4. The composition of claim 1 wherein said animal fat is Wagyu beef tallow and has an oleic acid value in the range of 42.5-45.3%.

5. The composition of claim 1 wherein said animal fat is Wagyu beef tallow and has a palmitoleic acid value in the range of 4.3-4.9%.

6. The composition of claim 1 wherein said animal fat is grass-fed beef tallow.

7. The composition of claim 1 wherein said animal fat is a mixture of one or more of Wagyu beef tallow, beef tallow, swine lard, bacon fat, or pork skin fat.

8. A canned cooking spray comprising:
a metal spray can;
a compressed inert gas;
a spray nozzle;
a cooking composition that is a pourable and sprayable liquid at room temperature (68-74° F.) comprising fractionated animal fat having a total saturated fat content approximately in the range of 33.9-34.7% including a palmitic acid content in the range of 20.4-20.7% and a stearic acid content in the range of 9.4-10.1%, a total monosaturated fat content approximately in the range of 49.3-52.5% which includes an oleic acid content in the range of 42.5-45.3%, a palmitoleic acid content in the range of 4.3-4.9%, a total polyunsaturated fat content approximately in the range of 2.4-3.0%, a total trans-fat content of 3.7-5.5%, a conjugated linoleic acid content approximately in the range of 0.65-0.68, a Mettler dropping point approximately in the range of 17-18° C., an iodine value approximately in the range of 56-64 g1/100 g, and a free fatty acid value approximately in the range of 0.4-0.7% ;
a food grade bag-on-valve (BOV) that houses the composition within the metal spray can and prevents direct contact of the composition with the compressed inert gas and metal spray can.

9. The canned cooking spray of claim 8 wherein said compressed inert gas is compressed air.

10. The canned cooking spray of claim 8 wherein said compressed inert gas is nitrogen or carbon dioxide.

11. The canned cooking spray of claim 8 wherein said animal fat is Wagyu beef tallow.

12. The canned cooking spray of claim 8 wherein said animal fat is grass-fed beef tallow.

13. The canned cooking spray of claim 8 wherein said animal fat is a mixture of one or more of Wagyu beef tallow, beef tallow, swine lard, bacon fat, or pork skin fat.

14. A method of flavoring savory foods comprising:
providing a cooking composition that is a pourable and sprayable liquid at room temperature (68-74° F.) comprising fractionated animal fat having a total saturated fat content approximately in the range of 33.9-34.7% including a palmitic acid content in the range of 20.4-20.7% and a stearic acid content in the range of 9.4-10.1%, a total monosaturated fat content approximately in the range of 49.3-52.5% which includes an oleic acid content in the range of 42.5-45.3%, a palmitoleic acid content in the range of 4.3-4.9%, a total polyunsaturated fat content approximately in the range of 2.4-3.0%, a total trans-fat content of 3.7-5.5%, a conjugated linoleic acid content approximately in the range of 0.65-0.68%, a Mettler dropping point approximately in the range of 17-18° C., an iodine value approximately in the range of 56-64 gI/100 g, and a free fatty acid value approximately in the range of 0.4-0.7%;
installing the composition in a spray can with a compressed inert gas and bag-on-valve;
positioning the spray can about 6 inches away from food or implement; and
pressing the nozzle of the spray can to release the composition from the spray can onto the food or implement.

15. The method of flavoring savory foods of claim 14 wherein said animal fat is Wagyu beef tallow.

16. The method of flavoring savory foods of claim 14 wherein said animal fat is grass-fed beef tallow.

17. The method of flavoring savory foods of claim 14 wherein said animal fat is a mixture of one or more of Wagyu beef tallow, beef tallow, swine lard, bacon fat, or pork skin fat.
